(19) United States
(12) Patent Application Publication
(10) Pub. No.: US 2026/0089374 A1
(43) Pub. Date: Mar. 26, 2026

(54) SYSTEM AND METHOD FOR SENSING OCCLUDED OBJECTS IN LOCATIONS OUTSIDE VEHICLE SENSOR FIELD-OF-VIEW

(71) Applicant: Torc Robotics, Inc., Blacksburg, VA (US)

(72) Inventors: Nicholas Atanasov, Austin, TX (US); Pablo Smith, Spicewood, TX (US); Akshay Pai Raikar, Austin, TX (US); William Gray Davis, Austin, TX (US); Christopher Harrison, Austin, TX (US)

(21) Appl. No.: 18/893,661

(22) Filed: Sep. 23, 2024

(51) Int. Cl. H04N 23/54; B60Q 1/24; G01J 5/00; G01J 5/08

(52) U.S. Cl. CPC H04N 23/54; B60Q 1/249; G01J 5/0859; G01J 2005/0077

(57) ABSTRACT

A system for occluded area detection for an autonomous vehicle that comprises at least one sensor associated with a vehicle. The at least one sensor is configured to be selectively positioned in a retracted position or a deployed position, wherein in the retracted position, a field-of-view of the at least one sensor is blocked such that the at least one sensor is incapable of detecting an area proximate to the vehicle, and in the deployed position, the field-of-view of the at least one sensor is exposed such that the at least one sensor is capable of detecting the area proximate to the vehicle. A system processing device is in communication with the at least one sensor, and the processing device is configured to execute instructions stored in a processing device memory to determine if the vehicle is in a non-stationary mode or a stationary mode, and thereby determine if the at least one sensor should be moved to the deployed position.

### TECHNICAL FIELD

The field of the disclosure relates to the detection of occluded objects for an autonomous vehicle that has stopped and, in particular, a system to safely redeploy the autonomous vehicle after a period when the autonomous vehicles has stopped.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technology is used while the vehicle is driving on the road and as mentioned can process a sensed environment to identify and classify objects, or groups of objects, in the environment, for example, pedestrians, vehicles, or debris. When a vehicle has to redeploy after a prolonged stop, i.e. traffic jam, minimum risk maneuver, or at stop light for example, it will need confirm that the path of the vehicle is clear to enable the vehicle to return safely to the road. The vehicle uses perception technology to confirm that the path to the road is clear, and without debris or other objects that could impede travel. Existing perception technology is able to view and sense the area along the sides and from and rear vehicle locations. However, in addition to the vehicle sides, front and rear locations, there are additional locations along the vehicle that need to be viewed and deemed clear of debris or other objects blocking the vehicle's path before redeploying an autonomous vehicle. These additional locations may include occluded objects that are not within the vehicle's field-of-view using existing perception technology, for example one such location is under the vehicle. To avoid vehicle damage, it is necessary to view these occluded locations to ensure that all debris is removed before vehicle redeployment. Accordingly, there exists a need for a system and a method to detect any occluded objects in order to ensure that the vehicle may redeploy after a prolonged stop.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect a system for occluded area detection is provided. The system comprises at least one sensor associated with a vehicle, where the at least one sensor is configured to be selectively positioned in a retracted position or a deployed position. In the retracted position, a field-of-view of the at least one sensor is blocked such that the at least one sensor is incapable of detecting an area proximate to the vehicle. In the deployed position, the field-of-view of the at least one sensor is exposed such that the at least one sensor is capable of detecting the area proximate to the vehicle. A processing device in communication with the at least one sensor so that the processing device is configured to execute instructions stored in a memory to perform operations to determine if the vehicle is in a non-stationary mode or a stationary mode. When the vehicle is in the stationary mode equal to or greater than a predetermined period of time, the at least one sensor in a deployed position to detect the area proximate to the vehicle. When the vehicle is in the non-stationary mode, the at least one sensor is in the retracted position.

In another aspect, a computer-implemented method for occluded area detection, is comprised of determining if a vehicle is in a non-stationary mode or a stationary mode. Instructions that are stored in a memory of a processing. The processing device is in communication with at least one sensor associated with the vehicle. Operations are performed that comprise placing the at least one sensor in a deployed position to detect an area proximate to the vehicle when the vehicle is in the stationary mode equal to or greater than a predetermined period of time. In the deployed position a field-of-view of the at least one sensor is exposed such that the at least one sensor is capable of detecting the area proximate to the vehicle. When the vehicle is in the non-stationary mode, it positions the at least one sensor in a retracted position. In the retracted position, the field-of-view of the at least one sensor is blocked such that the at least one sensor is incapable of detecting the area proximate to the vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous vehicle;

FIG. 2 is a block diagram of the autonomous vehicle shown in FIG. 1;

FIG. 3 is a block diagram of an example computing system;

FIG. 4 is a block diagram of an exemplary system 400 for vehicle failure detection;

FIG. 5 is a schematic view of an autonomous vehicle with trailer and sensor array;

FIG. 6 is a first side view of an autonomous vehicle;

FIG. 7 is a second side view of an autonomous vehicle;

FIG. 8A is a view of a sensor in a retracted position;

FIG. 8B is a view of the sensor of FIG. 8A transitioning from a retracted to a deployed position;

FIG. 8C is a view of the sensor of FIG. 8A in a deployed position;

FIG. 9A is a view of a sensor in a retracted position;

FIG. 9B is a view of the sensor of FIG. 9A in a deployed position;

FIG. 9C is a view of the sensor of FIG. 9A in a retracted position;

FIG. 10A is a view of a sensor in a retracted position;

FIG. 10B is a view of the sensor of FIG. 10A in a deployed state;

FIG. 11 is a illustrates a packaged sensor for the vehicle environment;

FIG. 12 illustrates the placement of camera and their field of view;

FIG. 13 is a block diagram of a redeployment processor; and

FIG. 14 is a method of redeployment.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, when a vehicle has to redeploy after a prolonged stop, i.e. traffic jam, minimum risk maneuver, at stop light, it will need specific occluded areas to be assessed prior to redeploying on its mission. An autonomous vehicle is aware of its surroundings while in an autonomous mode such as while driving along the road. When the vehicle is forced to stop, however, it no longer has the same situational awareness. The stop may be the result of a traffic stop whether for a traffic light, a traffic jam or maybe pulled to the side of the road for any reason. When the vehicle is ready to redeploy and is entering back into autonomous mode there may be impediments to doing so. There may be a car parked in front of the vehicle. There may be a pedestrian or an animal that is in the way. A person or animal may be in the space between the tractor and the trailer itself. Sensors placed around the vehicle such as cameras can view the surrounding area of the vehicle and from those images it may be determined that the area around the vehicle is clear and the vehicle may redeploy. The cameras may be used to detect the area proximate to the vehicle which comprises capturing a video or a photograph of the area. The decision to redeploy can be made by a processing system or the images can be telemetered back to a remote operator to clear the vehicle or redeployment.

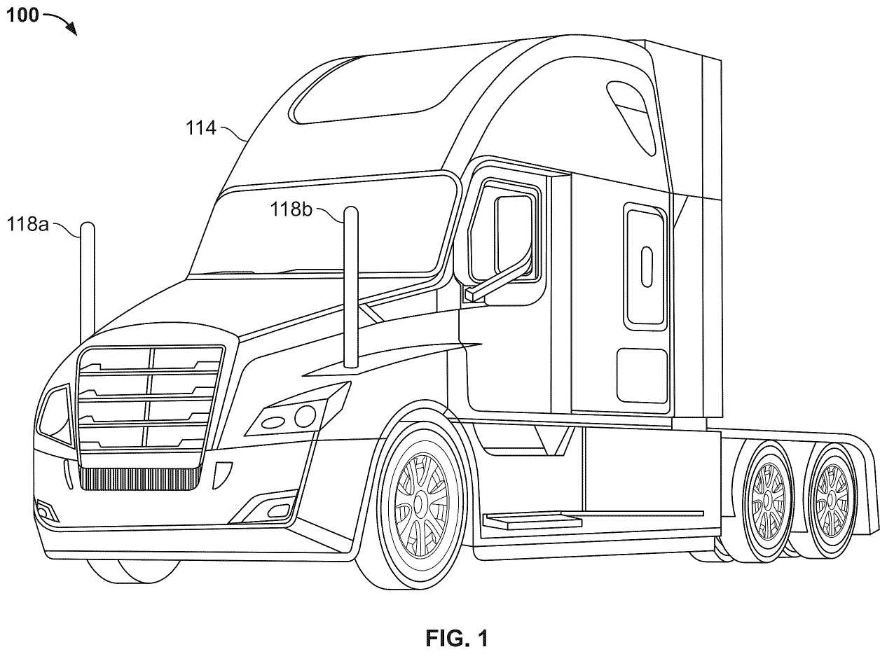

Various embodiments in the present disclosure are described with reference to FIGS. 1-12 below.

FIG. 1 illustrates a vehicle 100, such as a vehicle that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

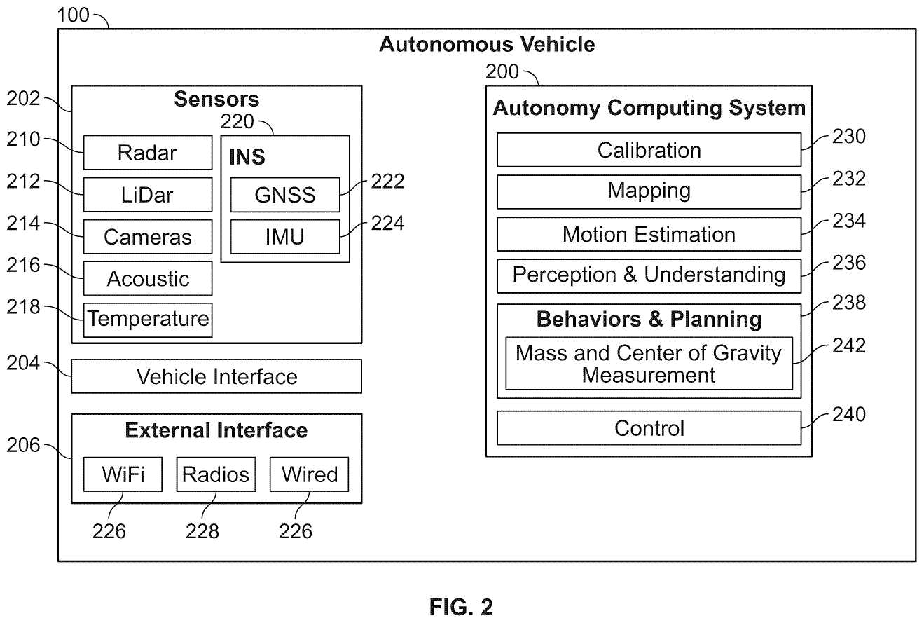

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and an object detection and reference path generator module 242. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

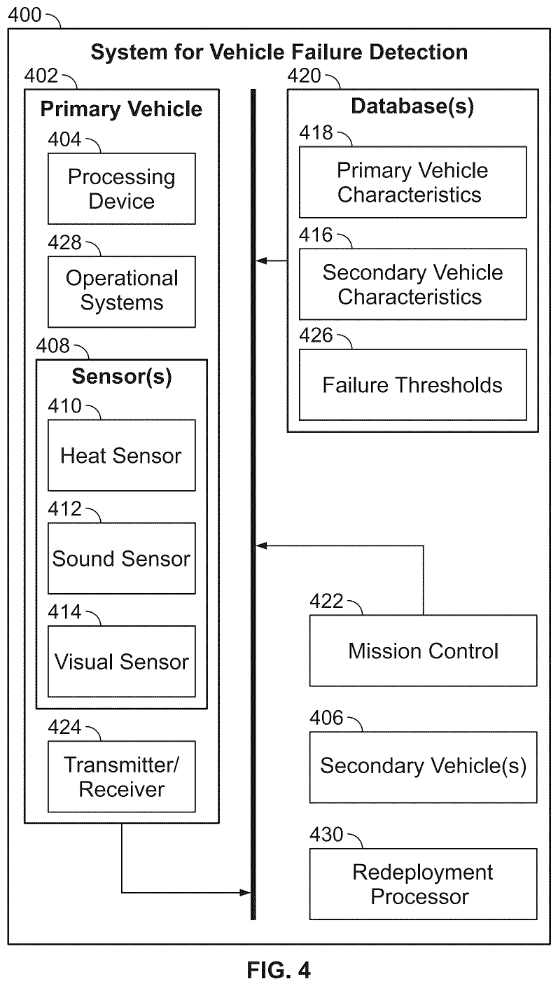

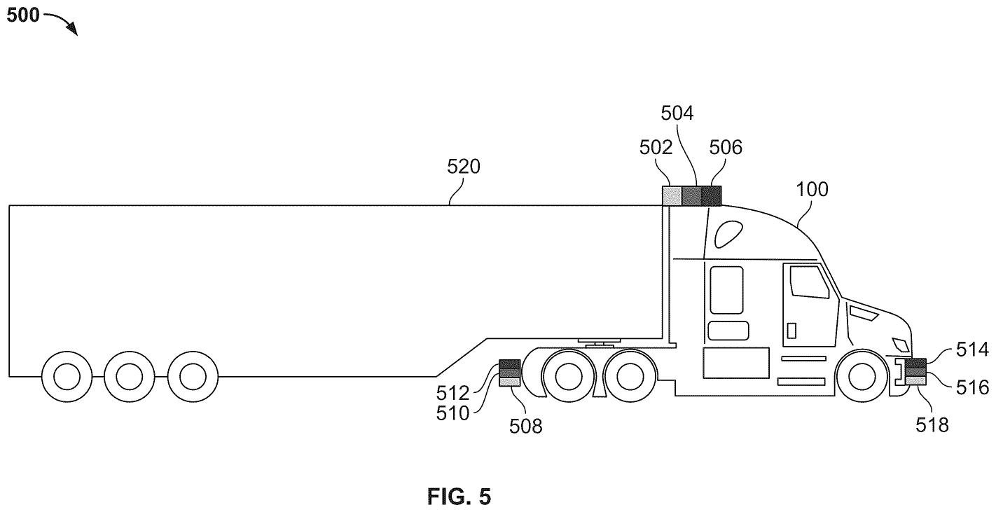

The object detection and reference path generator module 242 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both. Tasks performed by the object detection and reference path generator module 242 are described in detail using FIG. 4 and FIG. 5 below.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

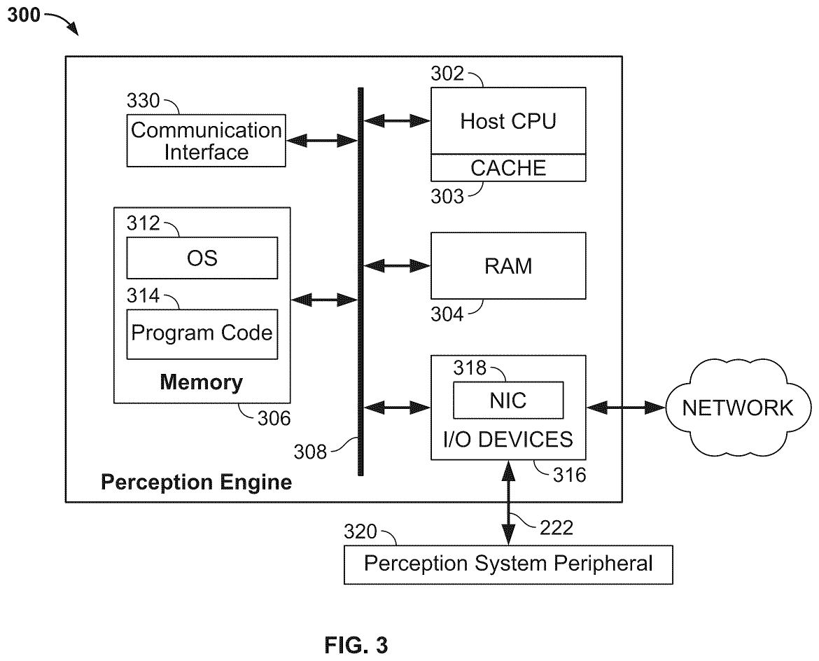

FIG. 3 is a block diagram of an example computing system 300, such as the autonomy computing system 200 shown in FIG. 2, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

FIG. 4 is a block diagram of an exemplary system 400 for vehicle failure detection. The system 400 generally includes one or more vehicles 402 (e.g., autonomous vehicle 100), i.e., primary vehicle. Each vehicle 402 includes various operational system 428, e.g., computing system 200, for controlling operation of the vehicle 402 and detecting objects, obstacles and other vehicles 406 around the vehicle 402. Each vehicle 402 includes a processing device 404 (e.g., computing system 200, computing system 300, or the like) configured to receive and process data for determining whether surrounding vehicles 406, e.g., secondary vehicles, have one or more component operational failures.

At least some of the data received by the processing device 404 can be data from one or more sensors 408 (e.g., sensors 202). For example, the sensors 408 can be used to physically detect the secondary vehicles 406 as the vehicle 402 travels along its route. The sensors 408 further detect certain characteristics 416 associated with the detected secondary vehicles 406. These characteristics 416 relate to the operational conditions of the secondary vehicles 406. In some embodiments, the sensors 408 can similarly be used to detect operational characteristics 418 or conditions of the vehicle 402 itself, thereby determining whether the vehicle 402 has one or more components undergoing failure. The sensors 408 are therefore usable to gather metrics on the vehicle 402 and surrounding vehicles 406. The detected characteristics 416, 418 can be electronically stored on one or more databases 420 in communication with the vehicle 402.

The vehicle 402 can include a variety of sensors 408, such as but not limited to, e.g., thermal or heat sensors 410, sound sensors 412, visual sensors 414, combinations there, or the like. These sensors 408 can be pointed or directed around the perimeter of the vehicle 402 to detect a variety of characteristics associated with vehicles 406 around the vehicle 402. In some embodiments, the heat sensor 410 can be an infrared sensor, although alternative heat sensors 410 could be used. In some embodiments, the sound sensor 412 can be a microphone, although alternative sound sensors 412 could be used. In some embodiments, the visual sensor 414 can be a camera, although alternative visual sensors 414 could be used.

The vehicle 402 can include one or more databases 420 (e.g., memory 306) configured to receive and electronically store data. In some embodiments, the database 420 can be stored externally from the vehicle 402 and the vehicle 402 can be in communication with the external database 420 for receiving and/or transmitting data associated with the system 400. For example, the database 420 can be in communication with both the vehicle 402 and mission control 422, such that data from the database 420 can be communicated to and from the vehicle 402 and mission control 422. In some embodiments, a transmitter/receiver 424 can be used as a communication means between the vehicle 402 and mission control 422 (as well as the secondary vehicles 406). The vehicle can also include a Redeployment Processor 430 that can assess occluded areas for obstacles prior to redeployment after a stop. The redeployment Processor 430 may be part of the vehicle processing device 404 or may be an external processor.

FIG. 5 is a schematic view of an autonomous vehicle with trailer and sensor array. The schematic shows three sets of sensors. The three sets of sensors enable viewing of locations that are out of the field-of-view provided by sensors 408. The first set of sensors are shown as 502, 504, and 506 in FIG. 5. Sensors 502, 504 and 506 are located near the top section of the vehicle 100 where it can sense the space between the vehicle 100 and the trailer 520. The sensors 502, 504 and 506 may be mounted on the side of the vehicle 100 with a view of the space between the vehicle 100 and the trailer 520. The sensors have two modes of operation. In the first mode of operation, the sensors 502, 504, 506 are retracted. When each sensor is retracted (or stowed), the sensor is not active and is in a position where the sensor lens or window is covered and protected from wind and airborne dirt when the sensor is not in use, for example as the autonomous vehicle drives along the road. In other words when the sensor is in the retracted position the field-of-view of the sensor is blocked such that the sensor is incapable of detecting an area proximate to the vehicle. The second mode of operation is when the sensors 502, 504, 506 are deployed and used to sense the locations that are out of the field of view of sensors 200 such as between the vehicle 100 and the trailer 520. In the deployed position, the field-of-view of the sensor is exposed such that the sensor is capable of detecting the area proximate to the vehicle. The sensor 502 in embodiments can be a camera that can capture images in the visible light spectrum and is capable of capturing images as video. Sensor 502 captures images of the space between the vehicle 100 and the trailer 520. Sensor 504 in embodiments is a camera that can capture images in the infrared spectrum or an infrared camera. It is also video capable and has two modes of operation, namely, stowed and deployed. Sensor 504 captures images of the space between the vehicle 100 and the trailer 520. The capabilities of sensors 502 and 504 may be combined into a single sensor such as a camera that can capture images in both the visible light spectrum and the infrared spectrum. The combined sensor will also operate in the two modes of operation, namely, retracted and deployed. The sensors 502 and 504 are not limited to a camera but may be any sensor that can sense objects in the space between the vehicle 100 and the trailer 520 such as RADAR, LiDAR, ultrasound, or infrared detectors. These sensors are similar to the sensors 202 of the system 200 previously described and represented schematically in FIG. 2. Sensor 506 in embodiments is an illumination source to illuminate an area proximate to the vehicle between the vehicle 100 and the trailer 520. In the case where cameras are used, 506 may be an illumination source of visible light. The visible light may be used to aid a visible light camera in capturing images.

The second set of sensors are shown as 508, 510, and 512 in FIG. 5. Sensors 508, 510, and 512 are located at the rear section (opposing the front section) of the vehicle near the bottom section (opposing the top section) of the vehicle 100 where it can sense the space underneath the vehicle 100 and trailer 520. The sensors 508, 510, and 512 are located on the rear cross beam of the vehicle 100 with a view of the space underneath vehicle 100 and the trailer 520. The sensors may be pointed forward to see mainly under the vehicle 100. The sensors may be pointed rearward to see the space under the vehicle and the trailer 520. The sensors have at least two modes of operation. In the first mode of operation, the sensors 508, 510, and 512 are retracted. When each sensor is retracted (or stowed), the sensor is not active and is in a position where the lens or sensor window is covered and protected from wind and airborne dirt when the sensor is not in use, for example as the autonomous vehicle drives along the road. In other words when the sensor is in the retracted position the field-of-view of the sensor is blocked such that the sensor is incapable of detecting an area proximate to the vehicle. The second mode of operation is when the sensors 508, 510, and 512 are deployed and used to sense the locations that are out of the field of view of sensors 408 such as such as the area under the vehicle 100 and the trailer 520. In the deployed position, the field-of-view of the sensor is exposed such that the sensor is capable of detecting the area proximate to the vehicle. The sensor 508 in the embodiments may be a camera that can capture images in the visible light spectrum and capable of capturing and collecting images used as a video. Sensor 508 captures images of the space under the vehicle 100 and the trailer 520. Sensor 510 in the embodiments may be a camera that can capture images in the infrared spectrum. It is also video capable and has at least two modes of operation, namely, a stowed mode of operation and a deployed mode of operation. Sensor 510 captures images of the space under the vehicle 100 and the trailer 520. The capabilities of sensors 508 and 510 may be combined into a single sensor such as a camera that can capture images in both the visible light spectrum and the infrared spectrum. The combined sensor will also operate in the two modes of operation, namely, a retracted mode of operation and a deployed mode of operation. The sensors 508 and 510 are not limited to a camera but may be any sensor that can sense objects in the space under the vehicle 100 and the trailer 520 such as RADAR, LiDAR, ultrasound, or infrared detectors. These sensors are similar to the sensors 202 previously described in system 200 represented in FIG. 2 and described herein. Sensor 512 in embodiments may be an illumination source to illuminate an area proximate to the vehicle under the vehicle 100 and the trailer 520. In the case where cameras are used, 512 may be an illumination source of visible light. The visible light may be used to aid the visible light camera in capturing images.

The third set of sensors are shown as 514, 516, and 518 of FIG. 5. Sensors 514, 516, and 518 are located at the front section of the vehicle 100 where it can sense the space in front of the vehicle 100. The sensors 514, 516, and 518 are located on the front grill of the vehicle 100 with a view of the space in front of the vehicle 100. The sensors have two modes of operation. In the first mode of operation sensors 514, 516, and 518 are retracted. When each sensor is retracted (or stowed), the sensor is not active and is in a position where the lens or sensor window is covered and protected from wind and airborne dirt when the sensor is not in use, for example as the autonomous vehicle drives along the road. In other words when the sensor is in the retracted position the field-of-view of the sensor is blocked such that the sensor is incapable of detecting an area proximate to the vehicle. The second mode of operation in the embodiments occurs when the sensors 514, 516, and 518 are deployed and used to sense the locations that are out of the field of view of sensor 408 such as in front of the vehicle 100. In the deployed position, the field-of-view of the sensor is exposed such that the sensor is capable of detecting the area proximate to the vehicle. The sensor 514 in the embodiments may be a camera that can capture images in the visible light spectrum and is capable of capturing images used as video. Sensor 514 captures images of the space in front of the vehicle 100. Sensor 516 in embodiments may be a camera that can capture images in the infrared spectrum. It is also video capable and has at least two modes of operation, namely, a stowed mode of operation and a deployed mode of operation. Sensor 516 captures images of the space in front of the vehicle 100. The capabilities of sensors 514 and 516 may be combined into a single sensor such as a camera that can capture images in both the visible light spectrum and the infrared spectrum. The combined sensor operates in the at least two modes of operation, namely, a retracted mode of operation and a deployed mode of operation. The sensors 514 and 516 are not limited to a camera but may be any sensor that can sense objects in the area in front of the vehicle 100. The sensors may comprise RADAR, LiDAR, ultrasound, or infrared detectors for example. These sensors are similar to the sensors 202 of the system 200 previously described in and illustrated in FIG. 2. Sensor 518 in embodiments may be an illumination source to illuminate an area proximate to the vehicle in front of the vehicle 100. In the case where cameras are used, 518 is a source of visible light. The visible light may be used to aid the visible light camera in capturing images.

FIG. 6 is a first side view of an autonomous vehicle. FIG. 6 shows a set of sensors 602, 604, and 608. These sensors enable viewing of locations that are out of the field-of-view provided by sensors 200. Sensors 602, 604, and 608 are located on a first side of vehicle 100 where it can sense the space adjacent to the first side of vehicle 100. The sensors 602, 604, and 608 may be mounted anywhere on the vehicle 100 where it can view the first side of vehicle 100. The sensors have two modes of operation. In the first mode of operation, the sensors 602, 604, and 608 are retracted. When each sensor is retracted (or stowed), the sensor is not active and is in a position where the lens or sensor window is covered and protected from wind and airborne dirt when the sensor is not in use, for example as the autonomous vehicle drives along the road. In other words when the sensor is in the retracted position the field-of-view of the sensor is blocked such that the sensor is incapable of detecting an area proximate to the vehicle. The second mode of operation occurs when the sensors 602, 604, and 608 are deployed and used to sense the locations that are out of the field of view of sensors 202 such as the area adjacent to the first side of vehicle 100. In the deployed position, the field-of-view of the sensor is exposed such that the sensor is capable of detecting the area proximate to the vehicle. The sensor 602 in embodiments may be a camera that can capture images in the visible light spectrum and may be capable of capturing images used as video. Sensor 602 captures images of the area adjacent to the first side of vehicle 100. Sensor 604 in embodiments may be a camera that can capture images in the infrared spectrum. It is also video capable and has at least two modes of operation, namely, a stowed mode of operation and a deployed mode of operation. Sensor 604 captures images of the space adjacent to the first side of vehicle 100. The capabilities of sensors 602 and 604 may be combined into a single sensor such as a camera that can capture images in both the visible light spectrum and the infrared spectrum. The combined sensor operates in at least two modes of operation, namely, a retracted mode of operation and a deployed mode of operation. The sensors 602 and 604 are not limited to a camera but may be any sensor that can sense objects in the space in front of the vehicle 100 such as RADAR, LiDAR, ultrasound, or infrared detectors. These sensors are similar to the sensors 202 of system 200 previously described and shown schematically in FIG. 2. Sensor 608 in embodiments is an illumination source to illuminate an area proximate to the vehicle adjacent to the first side of the vehicle 100. In the case where cameras are used, sensor 608 is an illumination source of visible light. The visible light may be used to aid the visible light camera in capturing images.

FIG. 7 is a second side view of an autonomous vehicle. FIG. 7 shows a set of sensors 702, 704, and 708. These sensors enable viewing of locations that are out of the field-of-view provided by sensors 202 of the system 200. Sensors 702, 704, and 708 are located on a second side of vehicle 100 where the sensors 702, 704, 708 sense the space adjacent to the second side of vehicle 100. The second side is the side opposite the first side. The sensors 702, 704, and 708 may be mounted anywhere on the vehicle 100 where the sensors 702, 704, 708 are able to view the second side of vehicle 100. The sensors have two modes of operation. In the first mode of operation the sensors 702, 704 and 706 are retracted. When each sensor is retracted (or stowed), the sensor is not active and is in a position where the lens or sensor window is covered and protected from wind and airborne dirt when the sensor is not in use, for example as the autonomous vehicle drives along the road. In other words when the sensor is in the retracted position the field-of-view of the sensor is blocked such that the sensor is incapable of detecting an area proximate to the vehicle. The second mode of operation is when the sensors 702, 704 and 708 are deployed and can sense the locations that are out of the field of view of sensors 20 such as the area adjacent to the second side of vehicle 100. In the deployed position, the field-of-view of the sensor is exposed such that the sensor is capable of detecting the area proximate to the vehicle. The sensor 702 in the embodiments may be a camera that is able to capture images in the visible light spectrum and is capable of capturing images used as video. Sensor 702 captures images of the area adjacent to the second side of vehicle 100. Sensor 704 in embodiments is a camera that can capture images in the infrared spectrum. It is also video capable and has at least two modes of operation, namely, a stowed mode of operation and a deployed mode of operation. Sensor 704 captures images of the space adjacent to the second side of vehicle 100. The capabilities of sensors 702 and 704 may be combined into a single sensor such as a camera can capture images in both the visible light spectrum and the infrared spectrum. The combined sensor operates in at least two modes of operation, namely, a retracted mode of operation and a deployed mode of operation. The sensors 702 and 704 are not limited to a camera but may be any sensor that can sense objects in the space in front of the vehicle 100 such as RADAR, LiDAR, ultrasound, or infrared detectors. These sensors 702 and 704 are similar to the sensors 202 of system 200 in FIG. 2 previously described. Sensor 708 in the embodiments may be an illumination source to illuminate an area proximate to the vehicle the area adjacent to the first side of the vehicle 100. In the case where cameras are used, sensor 708 may be an illumination source of visible light. The visible light may be used to aid the visible light camera in capturing images. Additionally, any of the sensors 702, 704, 708 described in the above may also be a motion sensor that can detect motion in its field of view.

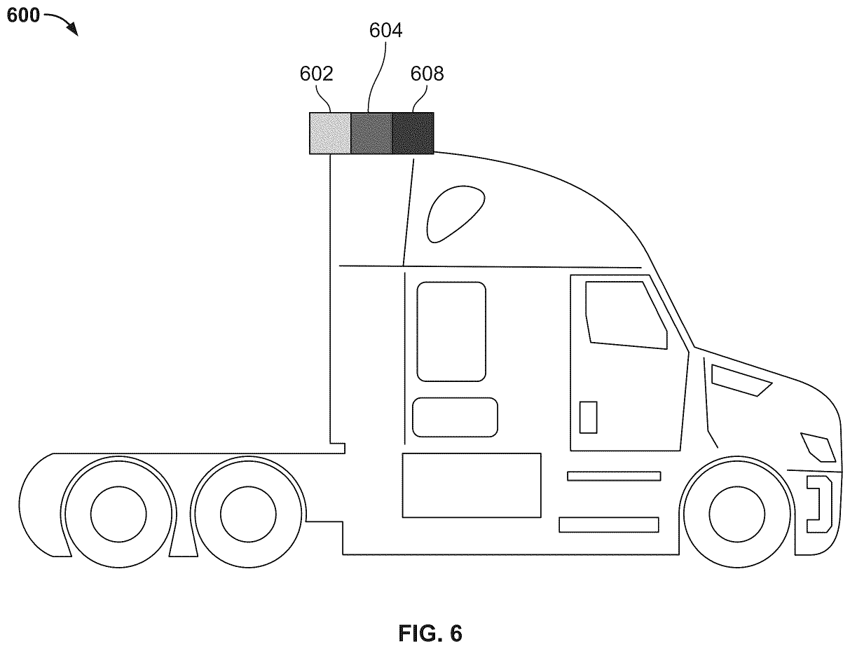

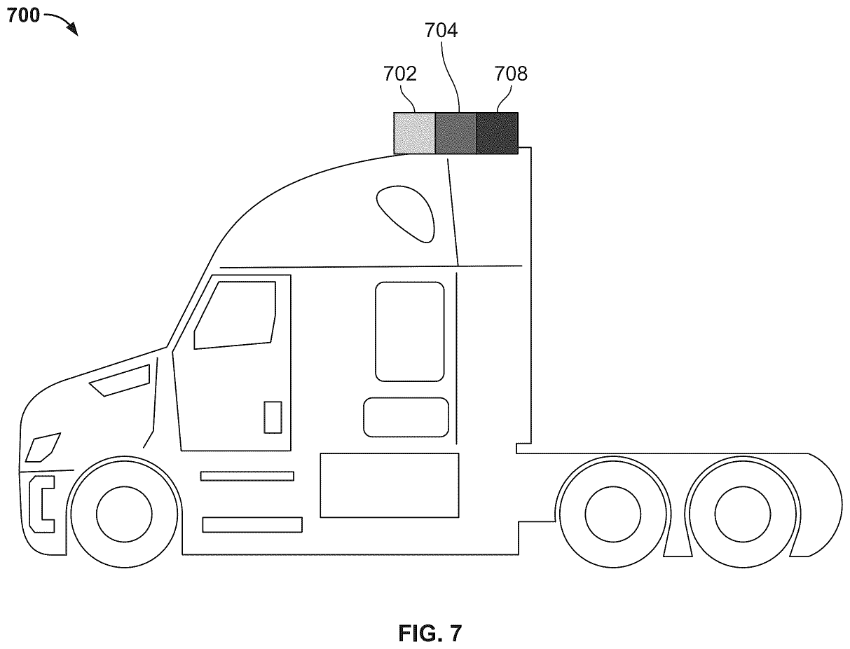

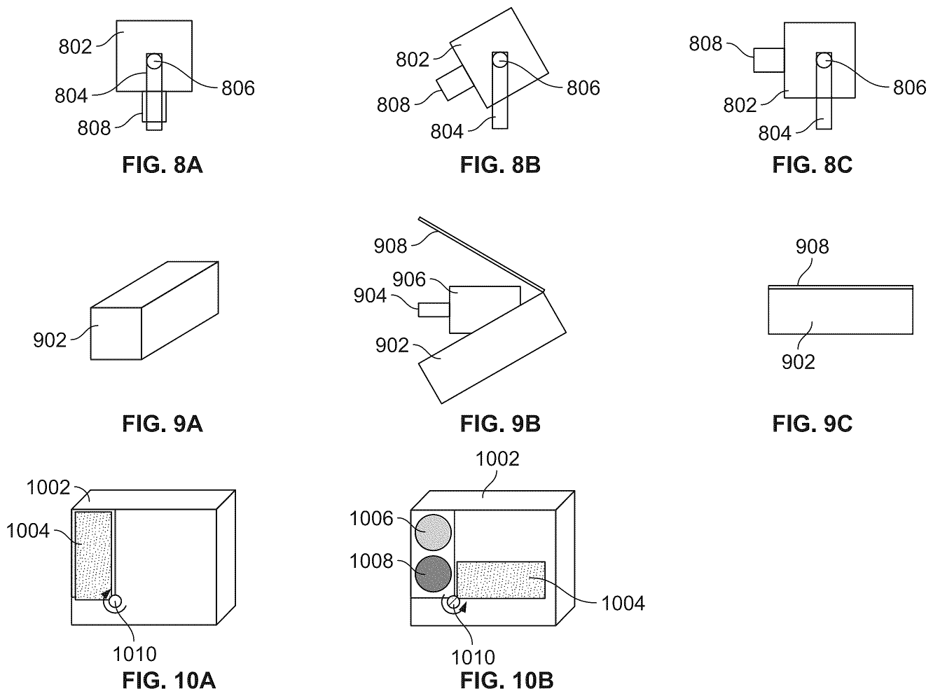

FIG. 8A is a view of a sensor in a retracted mode of operation. The sensor 802 in FIG. 8A is in retracted or stowed position. In retracted position the lens or sensor window 808 is not exposed to the wind and airborne dirt from the road. The sensor 802 is not active. The sensor 802 can pivot about a point 806 so that the sensor 802 is able to rotate. The sensor 802 is held by a bracket 804. FIG. 8B is a view of the sensor of FIG. 8A transitioning from a retracted mode of operation to a deployed mode of operation. As the sensor 802 transitions the sensor rotates about point 806 so that the lens or sensor window 808 moves to a position that enables the sensor to view the desired area along the vehicle. FIG. 8C illustrates the sensor 802 in a deployed mode of operation. In the deployed mode of operation, the sensor 802 is fully deployed, active and able to monitor the field of view along the vehicle. The images that sensor 802 senses and collects are telemetered to a redeployment processor that can evaluate the images and decide if there is any content in the camera images that comprises an object that may be blocking the vehicle 100 from redeploying. The sensor 802 can telemeter the data to a processor via a wired or wireless interface or telemeter the data to be stored on a cloud where remote operators can review the data in real time. One example of such a sensor is an Ethernet Camera.

FIG. 9A is a view of a sensor in a retracted mode of operation. The sensor is in a closed container 902 and is protected from weathering as well as dust and dirt from traffic conditions. Upon the receipt of a command signal, the sensor 906 is deployed. The deployed sensor is shown in FIG. 9B. The sensor 906 is shown with the at least the front portion of the sensor lens or window extending from the container 902 with the lens or sensor window 904 directed at the area it is to sense. A mechanical mechanism, not shown, such as a combined motor driving a rotating shaft opens the cover 908 and thereby directs the sensor 906 toward the area along the vehicle to be sensed. When the vehicle redeploys the sensor 906 and retracts the sensor back into the container 902, the mechanical mechanism closes the lid 908 as shown in FIG. 9C. The sensor 906 can telemeter the data to a processor via a wired or wireless interface or telemeter the data to be stored on a cloud where remote operators can review the data in real time.

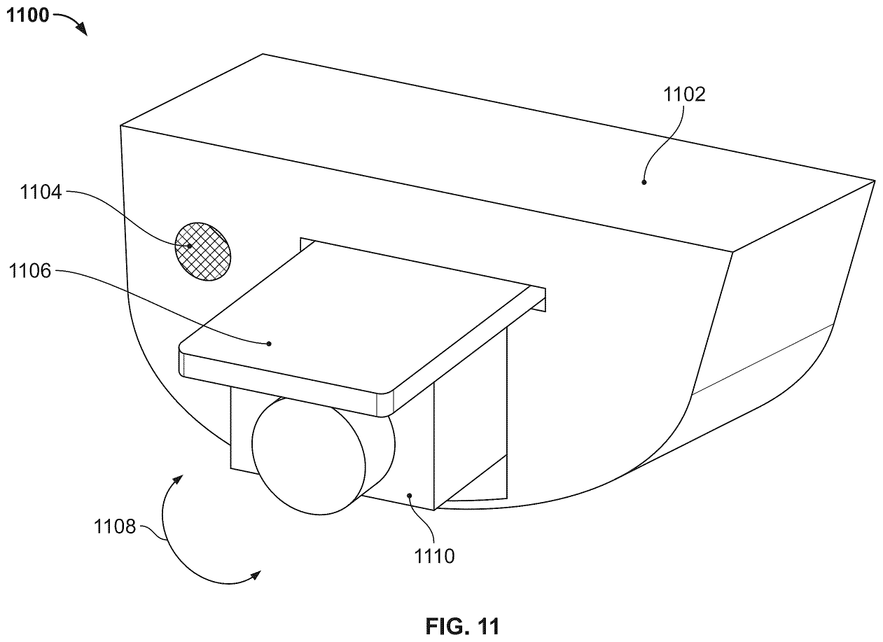

FIG. 10A is a view of a sensor in a retracted mode of operation. Sensor 1002 has a rotating element 1004 that pivots about axis 1010. Axis 1010 is located on the lower right hand side of rotating element 1004. When the sensor is deployed the element 1004 rotates about the pivot point and as a result, the lenses or sensor windows 1006 and 1008 are directed at an area to be sensed. In the embodiments, the lens of a camera 1006 captures images in visible light. Sensor window 1008 in the embodiments is a lens of a camera that images in the infrared spectrum. The rotating element 1004 rotates, but could alternatively translate such that the element 1004 slides linearly to expose the sensor windows 1006 and 1008 and to cover the windows when the sensor is retracted or stowed.

FIG. 11 shows a packaged sensor for the vehicle environment. The sensor in the embodiments may be a camera 1100 and is packaged inside a weatherproof housing 1102 when retracted and not in use. The sensor comprises a camera lens 1110 that protrudes outwardly from the housing when moved to a deployed mode of operation by a flip up mechanism 1106. The camera lens protrudes outwardly when in the active or deployed mode of operation. When the camera is in the retracted mode of operation, the lens 1110 is inside the housing and the flip up mechanism 1106 is closed, thereby protecting the lens from wind and airborne dirt. The lens 1110 may be automatically adjusted by rotating a focus 1108. The camera captures images in the visible light spectrum as well as the infrared spectrum. The camera 1100 has an illumination module 1104 in which it can illuminate its field of view proximate to the vehicle. A camera 1100 interfaces a redeployment processor via an Ethernet interface or a Gigabit Multimedia Serial Link (GMSL) interface. The sensor 1100 may contain a processing element where it can detect an occluded object within the sensor field of view. It also can contain a motion detector determining whether motion in the area exists. The sensor may also communicate the video to the redeployment process where the detection of an occluded object may occur within the redeployment processor, the vehicle controller or a remote processor.

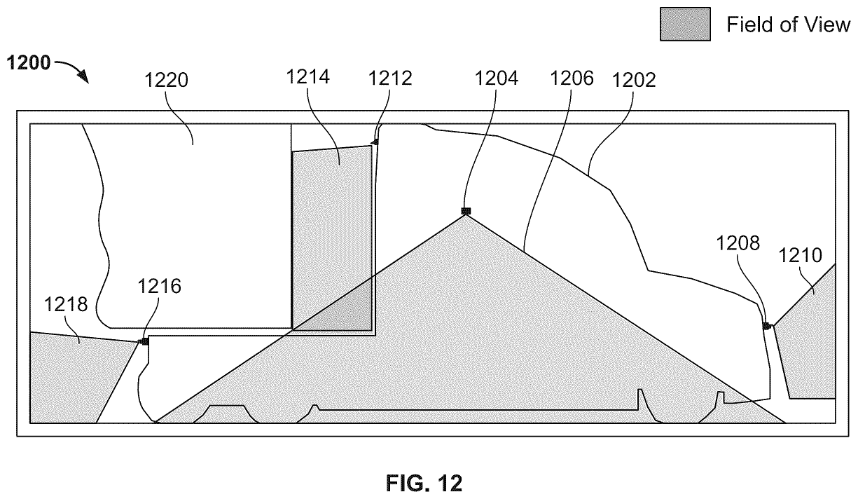

FIG. 12 illustrates the placement of a plurality of cameras mounted to an autonomous vehicle 1202. The camera 1204 is mounted to a first side of vehicle 1202 and has a field of view shown as 1206. The camera 1208 is mounted to a front section of autonomous vehicle 1202 and has a field of view shown as 1210. Camera 1212 is located at the top section of autonomous vehicle 1202 with a field of view 1214. Camera 1216 is located at the bottom section opposing the top section of autonomous vehicle directed behind the autonomous vehicle 1202 with a field of view shown as 1218. There is a camera (not shown) that is placed on a second side of the autonomous vehicle 1202, opposite camera 1204.

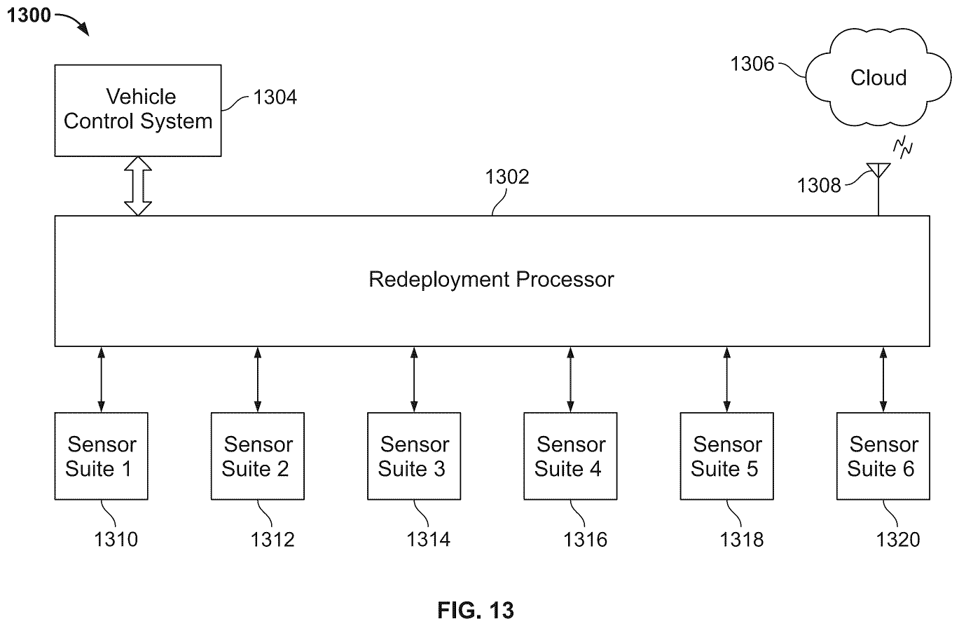

FIG. 13 is a block diagram of a redeployment processor. The redeployment processor 1302 is a processing device that communicates with the Vehicle Control System 1304. The redeployment processor 1302 a processing device that is in communication with a plurality of sensor suites in embodiments is a set of cameras. The redeployment processor communicates with sensor suite 1, identified at 1310, sensor suite 2, identified 1312, sensor suite 3, identified at 1314, sensor suite 4, identified at 1316 and sensor suite 5, identified at 1318 and sensor suite 6, identified at 1320. The redeployment processor interfaces each sensor suite using an Ethernet interface or a GMSL interface or any suitable digital interface including a wireless interface. The interface between each sensor suite and the redeployment processor 1302 is bidirectional. The redeployment processor can command each sensor suite 1310 to 1320 into a retracted or deployed position. The redeployment processor 1302 also has a wireless interface 1308 that can communicate with a Cloud 1306 and can upload the sensor data and images for review by a remote operator or by a remote processor. The Redeployment Processor may also be incorporated into the Vehicle Control System 1304.

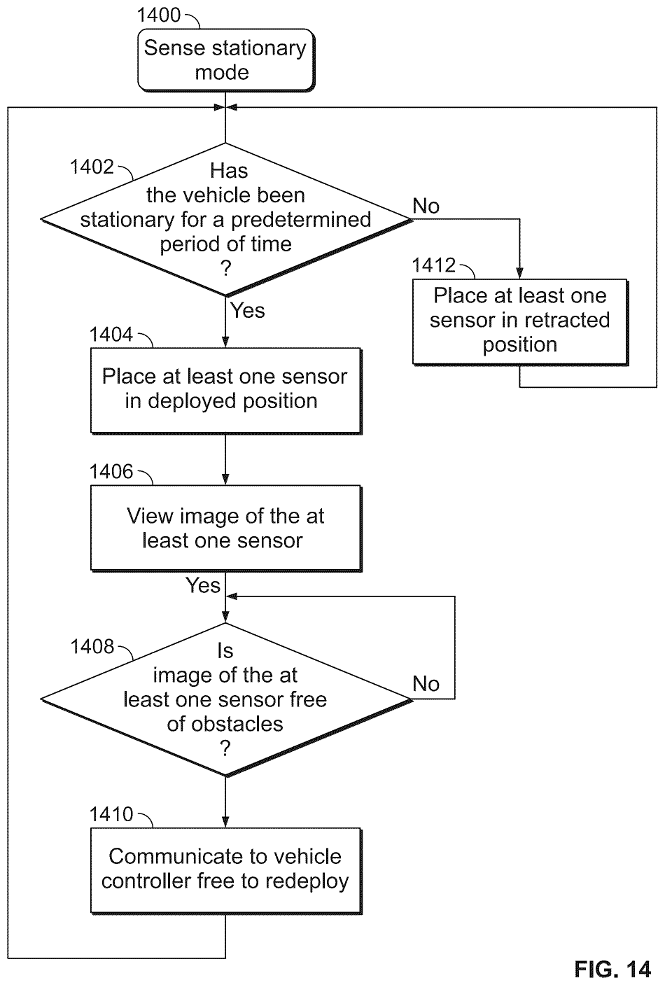

FIG. 14 is a method of redeployment. The method 1400 monitors the stationary state of the vehicle. A stationary mode is indicative that the vehicle is stopped. The method determines if the vehicle has been stationary for a predetermined period of time 1402. If the vehicle has not been stationary for a predetermined period of time the redeployment processor places at least one sensor into a retracted position 1412. A non-stationary mode is indicative of movement of the vehicle along a route. In the retracted position the sensor or camera is protected from wind and airborne dirt. In the case of a camera the lens is protected or covered or enclosed in its container. If the vehicle has been stationary for a predetermined period of time the redeployment processor places at least one sensor in a deployed position 1404. The sensor is active when in the deployed position and can capture images that the sensor is placed to the deployed orientation. The image can be evaluated by being viewed by the redeployment processor or by a remote process to determine if there are obstacles to redeployment 1406. In other words if the vehicle is in the stationary mode equal or greater than a predetermined period of time, the processor operations comprise determining if at least one sensor detects an occluded object in the area proximate to the vehicle. If the image is tested 1408 and if the image is not free of obstacles the image is tested again. If an occluded object is detected by at least one sensor proximate to the vehicle the vehicle control system prevents the deployment of the vehicle from the stationary to the non-stationary mode. If the image is free of obstacles the redeployment will communicate to the vehicle controller that the vehicle is free to deploy 1410. This test may be completed for each sensor. After all the sensors deem that the vehicle path is free of objects and obstacles, the communication indicating and representing that the vehicle is free for deployment 1410 is transmitted to the vehicle. The evaluation of the image for obstacles may be done in the redeployment processor, the vehicle processor, or may be telemetered back to a remote operator or a remote processor. The images may be sent to the cloud for evaluation by a remote processor or operator.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for occluded area detection, comprising:
at least one sensor associated with a vehicle, the at least one sensor configured to be selectively positioned in a retracted position or a deployed position, wherein (i) in the retracted position, a field-of-view of the at least one sensor is blocked such that the at least one sensor is incapable of detecting an area proximate to the vehicle, and (ii) in the deployed position, the field-of-view of the at least one sensor is exposed such that the at least one sensor is capable of detecting the area proximate to the vehicle; and
a processing device in communication with the at least one sensor, wherein the processing device is configured to execute instructions stored in a memory to perform operations comprising:
determining if the vehicle is in a non-stationary mode or a stationary mode;
if the vehicle is in the stationary mode equal to or greater than a predetermined period of time, positioning the at least one sensor in a deployed position to detect the area proximate to the vehicle; and
if the vehicle is in the non-stationary mode, positioning the at least one sensor in the retracted position.

2. The system of claim 1, wherein the operations comprise illuminating the area proximate to the vehicle with an illumination source when the at least one sensor is in a deployed position.

3. The system of claim 1, wherein the vehicle comprises a front section, a rear section opposing the front section, a top section, and a bottom section opposing the top section.

4. The system of claim 3, wherein the at least one sensor is mounted to the vehicle such that the area proximate to the vehicle is at or near the front section of the vehicle.

5. The system of claim 3, wherein the at least one sensor is mounted to the vehicle such that the area proximate to the vehicle is at or near the rear section of the vehicle.

6. The system of claim 3, wherein the at least one sensor is mounted under the vehicle such that the area proximate to the vehicle is at or near the bottom section of the vehicle.

7. The system of claim 1, wherein the vehicle is an autonomous vehicle.

8. The system of claim 1, wherein the at least one sensor is a camera and detecting the area proximate to the vehicle comprises capturing a video or photograph of the area.

9. The system of claim 8, wherein the camera is an Ethernet or GMSL camera.

10. The system of claim 8, wherein the camera is an infrared camera or a visible light camera.

11. The system of claim 1, wherein the at least one sensor is a motion detector and detecting the area comprises determining whether motion in the area exists.

12. The system of claim 1, wherein in the retracted position, the at least one sensor is protected from wind and airborne dirt.

13. The system of claim 1, wherein the non-stationary mode is indicative of movement of the vehicle along a route.

14. The system of claim 1, wherein the stationary mode is indicative that the vehicle is stopped.

15. The system of claim 1, comprising a vehicle control system in communication with the processing device.

16. The system of claim 15, wherein the vehicle control system is configured to actuate the vehicle to deploy from the stationary mode into the non-stationary mode, or to maintain the vehicle in the stationary mode.

17. The system of claim 15, wherein if the vehicle is in the stationary mode equal to or greater than the predetermined period of time, the operations comprise determining if the at least one sensor detects an occluded object in the area proximate to the vehicle.

18. The system of claim 17, wherein if the occluded object is detected by the at least one sensor in the area proximate to the vehicle, the vehicle control system prevents deployment of the vehicle from the stationary mode into the non-stationary mode.

19. The system of claim 17, wherein if the occluded object is not detected by the at least one sensor in the area proximate to the vehicle, the vehicle control system initiates deployment of the vehicle from the stationary mode into the non-stationary mode.

20. A computer-implemented method for occluded area detection, comprising:
determining if a vehicle is in a non-stationary mode or a stationary mode; and
executing instructions stored in a memory with a processing device in communication with at least one sensor associated with the vehicle to perform operations comprising:
if the vehicle is in the stationary mode equal to or greater than a predetermined period of time, positioning the at least one sensor in a deployed position to detect an area proximate to the vehicle, wherein in the deployed position a field-of-view of the at least one sensor is exposed such that the at least one sensor is capable of detecting the area proximate to the vehicle; and
if the vehicle is in the non-stationary mode, positioning the at least one sensor in a retracted position, wherein in the retracted position, the field-of-view of the at least one sensor is blocked such that the at least one sensor is incapable of detecting the area proximate to the vehicle.
